(19) United States
(12) Patent Application Publication
(10) Pub. No.: US 2020/0160451 A1
(43) Pub. Date: May 21, 2020

(54) TARGETED DIVIDEND REINVESTMENT PLANS AND METHODS OF ESTABLISHING SAME

(71) Applicant: Thomas Henderson, Nanaimo (CA)

(72) Inventor: Thomas Henderson, Nanaimo (CA)

(21) Appl. No.: 16/593,362

(22) Filed: Oct. 4, 2019

Related U.S. Application Data
(63) Continuation of application No. 15/869,335, filed on Jan. 12, 2018, now abandoned.
Application No. 15/869,335 is a continuation of application No. 15/290,158, filed on Oct. 11, 2016, now abandoned.
Application No. 15/290,158 is a continuation of application No. 13/614,742, filed on Sep. 13, 2012, now abandoned.
Application No. 13/614,742 is a continuation of application No. 12/876,661, filed on Sep. 7, 2010, now abandoned.
Application No. 12/876,661 is a continuation of application No. 12/240,384, filed on Sep. 29, 2008, now abandoned.
Application No. 12/240,384 is a continuation of application No. 11/029,403, filed on Jan. 6, 2005, now abandoned.
(60) Provisional application No. 60/637,662, filed on Dec. 21, 2004.
(60) Provisional application No. 60/534,393, filed on Jan. 7, 2004.

(51) Int. Cl. G06Q 40/06; G06Q 40/00; G06Q 99/00; G06Q 10/10

(52) U.S. Cl. CPC G06Q 40/06; G06Q 40/00; Y02P 90/90; G06Q 10/103; G06Q 99/00

(57) ABSTRACT

A method of establishing a targeted dividend reinvestment plan associated with environmental management projects, and financial securities generated therein. In one embodiment, the method comprises steps of providing a dividend reinvestment plan, identifying at least one environmental management project, generating financial securities (e.g. “green” shares or other financial instruments) associated with the environmental management project(s), receiving a direction from investors participating in the dividend reinvestment plan to invest funds through a purchase by the investor of financial securities associated with the environmental management projects, issuing the financial securities to investors, and allocating the funds to the environmental management project(s).

### CROSS-REFERENCE TO RELATED APPLICATIONS

This application is a continuation of prior application Ser. No. 15,869,335 filed Jan. 12, 2018, which is a continuation of application Ser. No. 15/290,158 filed Oct. 11, 2016, which is a continuation of application Ser. No. 13/614,742 filed on Sep. 13, 2012, which is a continuation of prior application Ser. No. 12/876,661, filed on Sep. 7, 2010, which is a continuation of Ser. No. 12/240,384, filed on Sep. 29, 2008, which is a continuation of U.S. patent application Ser. No. 11/029,403, filed on Jan. 6, 2005, which claims the benefit of U.S. Provisional Application No. 60/534,393 filed on Jan. 7, 2004 and U.S. Provisional Application No. 60/637,662 filed on Dec. 21, 2004. The entire contents of application Ser. Nos. 15,869,335, 15/290,158, 13,614,742, 12/876,661, 12/240,384, 11/029,403, Application Nos. 60/534,393, and 60/637,662 are hereby incorporated by reference.

### FIELD OF THE INVENTION

This invention relates generally to financial securities, and more specifically to dividend reinvestment plans (DRIPs).

### BACKGROUND OF THE INVENTION

When a company has identified a specific environmental management project, either as a risk or economic opportunity, the company may use the traditional methods of debt or equity financing to finance this environmental initiative. The company could also rely on free cash flow, draw on cash reserves or engage in off-balance sheet arrangements to meet its needs.

However, companies may be reluctant to fund this liability by accumulating debt or by diluting the holdings of existing shareholders, given a lack of demonstrated understanding among investors and equity analysts of the potential positive impact that environmental strategies can yield. Without this understanding, the near-term impact on traditional company valuation metrics and stock prices can be a significant disincentive for managers considering a necessary or desirable environmental program.

### SUMMARY OF THE INVENTION

Embodiments of the invention relate generally to a means by which companies can communicate their environmental strategies and attract adequate financing while not being penalized by equity analysts and the capital markets, and more particularly, in at least one embodiment, to dividend reinvestment plans in which proceeds are targeted to environmental management projects, thereby providing a clear link between environmental strategies and financial performance as well as other advantages that will be made apparent from the description provided herein.

In one broad aspect of the invention, there is provided a method of establishing a targeted dividend reinvestment plan associated with environmental management projects, the method comprising the steps of: providing a dividend reinvestment plan, wherein the dividend reinvestment plan facilitates investment of funds of investors participating therein; identifying at least one environmental management project; generating at least one financial security associated with the at least one environmental management project, each financial security being a financial instrument having associated therewith at least one instrument identifier that identifies the financial instrument; receiving a direction, from each of one or more investors participating in the dividend reinvestment plan, to invest at least a subset of the funds of the respective investor through a purchase by the respective investor of one or more of the at least one financial security associated with the at least one environmental management project; issuing one or more of the at least one financial security associated with the at least one environmental management project to each investor from which a direction is received; and allocating the at least a subset of funds of each investor from which a direction is received to the at least one environmental management project.

In another broad aspect of the invention, there is provided a financial security associated with the at least one environmental management project as generated at the generating step of the foregoing method.

### BRIEF DESCRIPTION OF THE DRAWINGS

For a better understanding of embodiments of the invention, and to show more clearly how they may be carried into effect, reference will now be made, by way of example, to:

FIG. 1, which is a flowchart illustrating steps in a method of establishing a targeted dividend reinvestment plan associated with environmental management projects in accordance with an embodiment of the invention.

### DETAILED DESCRIPTION OF EMBODIMENTS OF THE INVENTION

Traditionally, many industrial companies viewed the environment as a source of free inputs or as a free repository for waste. Any resulting environmental damage was seen as the inevitable cost of economic progress.

With the advent of increasing public awareness, governments at all levels began to broaden and strengthen environmental legislation. Strict liability regimes, and a host of other prescriptive regulations, began to associate large financial penalties with abuse of the environment.

Initially, companies vigorously resisted new environmental protection requirements and sought to reverse existing ones. Once they realized that these requirements would be enforced, they viewed expenditures on meeting them not only as necessary to remain in business, but also as a drag on profitability and as otherwise unrelated to the fulfillment of business objectives. These expenditures were to be minimized if they could not be avoided.

Companies eventually began adopting a proactive approach to environmental compliance by conducting internal environmental audits and implementing environmental management systems. The idea emerged that the redesign of production processes to reduce waste and environmental risk could improve operating margins, increase returns, and lower working capital expenses. Nevertheless, some equity investment analysts and investors believe that if environmental strategies matter at all to a company's financial performance, those strategies do so in terms of liabilities and risks.

A recent trend in socially responsible investment attempts to incorporate environmental strategy into investment decisions, but these analyses have largely been confined to evaluation of environmental performance without reference to financial performance. They do not typically attempt to directly relate environmental protection strategies to the business strategies of the companies studied.

Generally, environmental performance data made available by companies is not developed to meet the needs of financial analysts. Because no recognized standard exists for the gathering of this data, this data is difficult to compare across companies. Finally, if such performance is not defined with reference to the operational objectives of individual companies and specific industries, it will not typically be relevant to analysts, managers and investors.

A survey by the United Nations Environment Programme (UNEP)

Financial Institutions Initiative (“Finance for Carbon Solutions, The Clean Development Mechanism: The Financial Sector Perspective”, January 2005) and a separate study by the United States Environmental Protection Agency on the environment (“Green Dividends?: The Relationship Between Firms' Environmental Performance and Financial Performance”, May 2000), the contents of which are herein incorporated by reference, suggests that the lack of means to translate environmental issues into financial terms may be the greatest single barrier to integrating information about environmental strategies into financial analysis.

Within the financial services industry, virtually none of the traditional valuation techniques used by equity analysts explicitly addresses environmental strategies, yet equity investors have a stake in the potential of these strategies to reduce risks and increase margins, revenues, earnings, and returns on invested capital.

As noted earlier, when a company has identified a specific environmental management project, either as a risk or economic opportunity, the company may use the traditional methods of debt or equity financing to finance this environmental initiative. The company could also rely on free cash flow, draw on cash reserves or engage in off-balance sheet arrangements to meet its needs. However, companies may be reluctant to fund this liability by accumulating debt or by diluting the holdings of existing shareholders, given a lack of demonstrated understanding among investors and equity analysts of the potential positive impact that environmental strategies can yield. Without this understanding, the near-term impact on traditional company valuation metrics and stock prices can be a significant disincentive for managers considering a necessary or desirable environmental program.

Accordingly, a means by which companies can communicate their environmental strategies and attract adequate financing, while not being penalized by equity analysts and the capital markets is desirable.

In addition to access to traditional capital market funds, mature, sizable and profitable companies generally have access to after-tax cash flow to fund new projects. Often, however, a significant portion of these funds is typically paid out in regular dividend payments. Traditional equity analysis involves many financial characteristics, and equity analysts and investors frequently judge the quality and stability of an investment by the company's dividend record. Changes in a company's dividend can often have a significant impact on its share price. This results in companies being reluctant to reduce dividend rates, even if it must borrow to fund the expense.

As a result, some companies implement dividend reinvestment plans, otherwise known as a DRIP programs (or DRIPs). In typical implementations, DRIPs provide a quarterly, contractual, share-redemption vehicle for shareholder reinvestment of after-tax earnings that would otherwise leave the company as dividends.

DRIPs may benefit investors because there is typically no commission to be paid, they are generally flexible in the amount that investors are able to invest depending on their financial position, they inherently feature dollar cost averaging, and some DRIP programs offer shares of stock at a discount from its spot price in the market.

From a company's perspective, DRIPs generally offer low-cost access to capital. The DRIP shares are bought directly from the company, and the proceeds from buying the shares are then reinvested into the company. Companies also get a stable shareholder base that typically has a long-term investment style. DRIP shares are less liquid than shares in a regular brokerage account and selling them usually requires an investor to contact the company in order to sell the shares in their DRIP account.

Some companies run DRIP programs themselves. In this case, an investor relations department of a company typically handles all aspects of the plan, sometimes even allowing individuals to buy a share of the company to register for a DRIP account directly from this department as opposed to a broker. Some companies may even offer Individual Retirement Accounts (IRAs) along with the DRIP. Other companies may contract with a transfer agent to act on their behalf to handle DRIP program implementation details.

DRIPs, in their current conventional form, are not linked, marketed, or targeted to any distinct initiative or operational plan. Since their inception, DRIP proceeds have been put back into general funds or working capital, or in some cases, used to buy back the shares issued by the DRIP. Companies that implement conventional DRIPs retain complete control with respect to the use of these returned funds, and this may have been regarded historically by those companies as a significant benefit of DRIPs. The result has been that proceeds are not allocated to any specific productive purpose in DRIP contracts between companies and its shareholders.

The invention relates generally to the provision of dividend reinvestment plans in which proceeds are targeted to explicitly specified projects. These plans are referred to herein generally as targeted dividend reinvestment plans. In embodiments of the invention described herein, the specified projects comprise environmental management projects.

The targeted dividend reinvestment plans allow a company to declare a dividend to the market-at-large, while providing investors with the option of reinvesting the dividend such that it is specifically allocated to environmental management projects. These plans provide a clear link between environmental strategies and financial performance, as well as other advantages.

For example, as companies are typically permitted to sell securities through a dividend reinvestment plan without the need to retain a broker to issue the securities, cost savings may be achieved. Furthermore, embodiments of the invention provide a market-driven framework that facilitates investment activity and is consistent with standard financial practices, provides securities that can be traded in a common format, and allows progress to be measured. Other advantages will be apparent from the features described below.

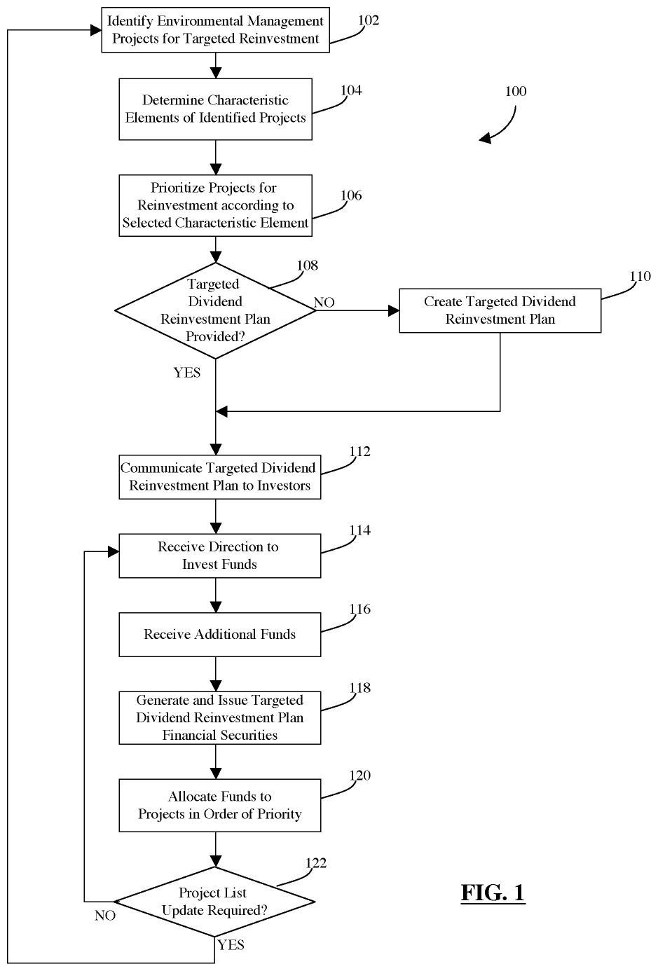

Referring to FIG. 1, a flowchart illustrating steps in a method of establishing a targeted dividend reinvestment plan associated with environmental management projects in accordance with an embodiment of the invention is shown generally as 100.

In this description and in the appended claims, the term “dividend reinvestment plan” is used generally to describe not only conventional DRIPs, but is also deemed to include, for example, Direct Stock Purchase Plans (DSPPs), Optional Cash Purchase Plans (OCPs), Supplementary Purchase Plans (SPPs), and other direct stock purchase plans by shareholders known in the art, even though it will be understood by persons skilled in the art that some of these plans may technically differ in certain aspects that are not material in the context of this embodiment of the invention. For example, to participate in a company's DRIP program, an investor typically needs to own at least one share of stock, whereas for a DSPP, investors are typically permitted to buy stock directly from the company even prior to owning any shares.

Although the term DRIP may imply that only dividends are reinvested, often these plans also allow investors the opportunity to periodically buy shares through the plan with direct stock purchases using additional cash, often up to a yearly maximum. Such plans are also intended to fall within the definition of “dividend reinvestment plan” as used herein.

In this description and in the appended claims, reference is made to the investment of funds of investors participating in a dividend reinvestment plan. The term “investment” and derivations of the term is used generally herein, and includes, for example, acts that may be otherwise be described using the term “reinvestment” and respective derivations thereof. Furthermore, the “funds” of an investor participating in a dividend reinvestment plan are deemed to include not only dividends or other proceeds that would otherwise be paid to the investor if they were not reinvested, but also other contributions to the dividend reinvestment plan (e.g. additional cash for a direct stock purchase) that may be received from the investor, for example.

At step 102, one or more specific environmental management projects are identified, potentially selected from a larger set of defined environmental management projects. Optionally, these can be drawn from project data stored in a company's environmental management system. The identified projects may comprise projects that reflect identified ongoing operating and processing risks that are known and current, such as pollution abatement, monitoring, or other activities required to comply with environmental regulations, for example. The identified projects may comprise projects that address contingent environmental activities that are known and possible, such as prevention, detection and response means, or known environmental risks that may represent potential future liability, for example. The identified projects may comprise projects relating to environmental sustainability. For example, a forestry company may define a project to clean up waste effluent in water and dioxins in the air, or to reforest harvested land. Other projects relating to any environmental issue that the company might wish to address may also be identified at this step.

At step 104, characteristic elements of the environmental management projects identified at step 102 are determined. Examples of characteristic elements of a given project may include costs needed to integrate the project into current operations. For instance, all equipment, installation and service costs, upgrade costs, personnel, and other costs associated with the project may be identified at this step. Other examples of characteristic elements of the given project may include timelines needed to integrate the project into current operations, risks associated with completion of the project, or, in the case of contingent risks, the cost and probability associated with a negative occurrence of some environmental event. Subsequently, at step 106, the environmental management projects identified at step 102 may be sorted and prioritized according to at least one selected characteristic element from the characteristic elements determined at step 104.

At step 108, a determination is made as to whether the company currently provides a targeted dividend reinvestment plan. A targeted dividend reinvestment plan not only may provide features of conventional DRIPs, but also includes an enforceable obligation by the company to divert at least a portion of funds of the investors participating in the targeted dividend reinvestment plan to one or more targeted environmental management projects. In this embodiment, the targeted environmental management projects include at least a subset of the environmental management projects identified at step 102. Funds may be diverted to these projects in priority order as determined at step 106.

If the company currently does not provide a targeted dividend reinvestment plan as determined at step 108, a targeted dividend reinvestment plan can be created at step 110 before the flow of method steps proceeds to step 112. Step 110 may require a new targeted dividend reinvestment plan to be set up, or an existing dividend reinvestment plan to be altered in order to create the targeted dividend reinvestment plan. It will be understood that in the latter scenario, it is not essential to have any particular type of dividend reinvestment plan in place, and that modifications of any of a number of different types of plans might be made at this step. As may be required when creating any dividend reinvestment plan, an agency service provider can be selected, internal administrative procedures can be established, and activities relating to compliance with governing legislation can be performed at this step.

On the other hand, if the company currently provides a targeted dividend reinvestment plan as determined at step 108 (e.g. as created in an earlier step, either at step 110 of a previous iteration of method 100 or at a step not shown in FIG. 1), the flow of method steps proceeds to step 112.

At step 112, the company communicates the availability of the targeted dividend reinvestment plan with persons having a potential interest in the company's environmental program or potential participants in the targeted dividend reinvestment plan. Details and features of the targeted dividend reinvestment plan, the environmental management projects as identified at step 102 or a subset thereof, the characteristic elements determined at step 104 or a subset thereof, and/or the prioritization by characteristic element of the identified environmental management projects as determined at step 106 may also be communicated at step 112. Individuals or entities that participate or will potentially participate in the plan are referred to herein generally as investors.

At step 114, once a targeted dividend reinvestment plan is in place, a direction to invest funds towards the targeted environmental management projects is received from one or more of the investors participating in the plan. The funds of each investor from which a direction is received includes dividends or other proceeds that would otherwise be paid to the investor, and optionally, additional contributions to the dividend reinvestment plan (e.g. additional cash for a direct stock purchase) that may be received from the investor at step 116. Under current legislation, the investors of which funds are invested will generally be current shareholders of the company, but may potentially also include other stakeholders.

The direction received from any given investor at step 114 may be in the form of explicit instructions provided with respect to particular proceeds and/or additional contributions, or it may arise automatically from instructions previously provided by the investor to invest proceeds and/or additional contributions on a recurring basis.

The funds to be invested towards the targeted environmental management projects, as directed by any given investor at step 114 or otherwise defined in an agreement between the investor and the company, may, but need not include all of the dividends or proceeds payable to the investor and the additional contributions received from the investor. In variant implementations of the targeted dividend reinvestment plan, a portion of the funds may be subject to investment, possibly determined as a percentage of proceeds or as a fixed maximum amount, for example.

At step 118, the company generates and issues targeted dividend reinvestment plan financial securities to the investors from which a direction is received at step 114. These financial securities are associated with the targeted environmental management projects identified at step 102, and represent a contractual assurance to investors that their funds are to be allocated to at least some of the targeted environmental management projects.

In one embodiment of the invention, each financial security issued is an equity share, and more specifically, a separately tradeable form of common share that is specifically linked and identified as relating to the targeted dividend reinvestment plan. Each share may be traded in existing markets, and a separate trading framework does not need to be designed or employed to facilitate trading. Each share is represented by a share certificate, which is typically a physical certificate, although in some embodiments the share certificate may be in an electronic form. The share certificate can be uniquely identified by one or more instrument identifiers, which may include an issuer name, an issue date, and a certificate or serial number, for example. The certificate or serial number or other instrument identifier may be generated so as to clearly identify a share as relating to a targeted dividend reinvestment plan associated with environmental management projects. Shares that are specifically associated with at least one environmental management project are also referred to herein as “green” shares, although other descriptive terms may be used.

It will be understood by persons skilled in the art that the generation and the issuance of the targeted dividend reinvestment plan financial securities may be performed in distinct, separate steps. For example, the financial securities may be generated and stored as company stock, for issuance to specific investors at some subsequent point in time. It will also be understood that examples of the financial securities that may be generated and issued at step 118 include, but are not limited to, common, preferred and hybrid shares, stapled units, as well as debt, debenture, insurance or lease instruments. These may be referred to herein more generally as “green” financial instruments, as they are specifically associated with environmental management projects identified in the targeted dividend reinvestment plan.

At step 120, the company allocates funds (or a subset thereof) to be invested, as directed at step 114, to identified environmental management projects in order of priority as determined at step 106. It will be understood by persons skilled in the art that steps related to the accounting of allocations made can be performed in known manner. The company is expected to implement the environmental management projects, and track completion and project performance for periodic reporting to targeted dividend reinvestment plan participants (step not shown).

The steps of method 100 may be repeated so that further funds may be allocated to previously identified and/or new environmental management projects. In one embodiment, some of these steps (e.g. steps 114-120) are repeated periodically (e.g. quarterly, annually) so that a potentially continuous, cash stream of funds to fund the company's environmental management projects can be generated. Furthermore, from time to time, the prioritized list of environmental management projects can be updated. At step 122, the prioritized environmental management projects is reviewed and can be updated to ensure that the set of identified environmental management projects to be targeted is complete, their respective characteristic elements are correct and the selected characteristic elements used for prioritization are aligned with the company's environmental strategy. If required, earlier steps of method 100 may be repeated to update the prioritized list, otherwise the targeted dividend reinvestment plan continues to be managed while funds may be periodically received from investors at step 114.

In a variant embodiment, investors may be permitted to rescind their participation in the targeted dividend reinvestment plan, and take the dividend payable to them and/or sell or transfer the “green” shares or other financial instruments to another party. It will be understood that the account records of the company will be updated accordingly.

It will be understood by persons skilled in the art that method 100 may comprise steps not explicitly shown in FIG. 1 relating to the performance of activities necessary to comply with applicable securities legislation.

As described earlier, a targeted dividend reinvestment plan provided in accordance with a broad aspect of the invention can be based on any of a number of programs including conventional DRIPs, DCPPs, OCPs, and SPPs, for example. It will also be understood by persons skilled in the art that the methods described herein may also be extended to other forms of investment programs, such as employee stock plans, for example.

Although embodiments of the invention have been described herein with respect to targeted dividend reinvestment plans that facilitate the funding of environmental management projects, the invention may, in variant embodiments, have applications to projects other than environmental management projects. These may include, for example, the funding of contingent liability projects, the funding of infrastructure improvement or replacement projects, and for any other identified projects that are not necessarily environment-related for which the company requires funding, for example.

The invention has been described with regard to a number of embodiments. However, it will be understood by persons skilled in the art that other variants and modifications may be made without departing from the scope of the invention as defined in the claims appended hereto.

1. An electronic device for automatically implementing a targeted dividend reinvestment plan associated with environmental management projects, the electronic device comprising:
a memory storing computer readable instructions, and an electronic database including investor records and environmental project records; and
one or more processors configured to execute the computer readable instructions, wherein the computer readable instructions configure the one or more processors to collectively:
identify from records in the electronic database, dividends payable to at least one investor participating in a dividend reinvestment plan;
identify from records in the electronic database, at least one environmental management project;
generate and store in memory, at least one electronic share certificate associated with the identified environmental management project;
record in memory receipt of user input comprising a direction from the at least one investor to invest at least a subset of the dividends payable to the at least one investor by purchasing one or more of the at least one electronic share certificate associated with the at least one environmental management project;
record in the memory, an issuance of the one or more of the at least one electronic share certificate associated with the at least one environmental management project to the at least one investor; and
record in memory, allocation of the at least a subset of the dividends payable to the at least one investor to the at least one environmental management project.

2. The electronic device of claim 1, wherein the at least one electronic share certificate is associated with one or more of the financial instruments selected from the following group: an equity share, an index fund, an equity fund, an insurance instrument, a re-insurance instrument, a lease instrument, a derivative instrument, and a hybrid financial instrument.

3. The electronic device of claim 1, further comprising the processor allocating an additional contribution from the at least one investor to the at least one environmental project.

4. The electronic device of claim 1, further comprising the processor retrieving the project data from an environmental management system.

5. The electronic device of claim 1, wherein the at least one electronic share certificate associated with the at least one environmental management project is tradeable.

6. The electronic device of claim 1, wherein the allocating is repeated periodically.

7. The electronic device of claim 1, wherein the processor is configured to associate at least one instrument identifier with the at least one electronic share certificate, wherein the at least one instrument identifier uniquely identifies the at least one electronic share certificate, and wherein the at least one instrument identifier comprises at least one of the instrument identifiers selected from the following group: an issuer name, an issue date, and a certificate number.

8. The electronic device of claim 1, wherein the processor identifying at least one environmental project comprises selecting the at least one environmental project from a plurality of environmental management projects for which project data is stored.

9. The electronic device of claim 8, further comprising the processor prioritizing the plurality of environmental management projects prior to the processor selecting the at least one environmental project from the plurality of environmental management projects.
